(19) United States
(12) Patent Application Publication
(10) Pub. No.: US 2026/0129126 A1
(43) Pub. Date: May 7, 2026

(54) METHOD AND APPARATUS FOR PROCESSING CALL TASK, AND COMPUTER-READABLE STORAGE MEDIUM

(71) Applicant: Mashang Consumer Finance Co., Ltd., Chongqing (CN)

(72) Inventor: Li HE, Chongqing (CN)

(21) Appl. No.: 19/283,567

(22) Filed: Jul. 29, 2025

(30) Foreign Application Priority Data
Nov. 4, 2024 (CN) 202411562736.8

(51) Int. Cl. H04M 3/523

(52) U.S. Cl. CPC H04M 3/5234

(57) ABSTRACT

A method and apparatus for processing a call task, a device, a computer-readable storage medium, and a computer program product are provided. The method includes: acquiring a weight assigned to a free agent for a call task; acquiring call parameters for executing the call task during a first time period; determining a number of calls during a second time period based on the assigned weight and the call parameters; and executing the call task based on the number of calls and the assigned weight.

### CROSS-REFERENCE TO RELATED APPLICATION

This application claims the benefit of priority of Chinese Patent Application No. 202411562736.8, filed on Nov. 4, 2024, the content of which is incorporated herein by reference in its entirety for all purposes.

### BACKGROUND

A call center is an important bridge for communication between enterprises and users, and a fluctuation in a number of calls directly affects the quality and efficiency of a user service. With the development of informatization and digitalization, the call center has an increasing demand for predicting the number of calls. A call center system usually relies on experience to adjust call resources, such as increasing or decreasing a number of agents, adjusting a time in call, etc., so as to cope with the fluctuation in the number of calls.

### SUMMARY

Embodiments of the disclosure provide a method and apparatus for processing a call task, and a computer-readable storage medium, which can improve an efficiency of processing the call task.

The technical solutions in the embodiments of the disclosure are implemented as follows.

An embodiment of the disclosure provides a method for processing a call task, which includes the following operations.

A weight assigned to a free agent for a call task is acquired.

Call parameters for executing the call task during a first time period are acquired.

A number of calls during a second time period is determined based on the assigned weight and the call parameters. The first time period and the second time period are adjacent time periods.

The call task is executed based on the number of calls and the assigned weight.

An embodiment of the disclosure provides an apparatus for processing a call task, which includes: a memory, configured to store a computer-executable instruction or a computer program; and a processor, configured to execute the computer-executable instruction or the computer program stored in the memory to: acquire a weight assigned to a free agent for a call task; acquire call parameters for executing the call task during a first time period; determine a number of calls during a second time period based on the assigned weight and the call parameters, the first time period and the second time period being adjacent time periods; and execute the call task based on the number of calls and the assigned weight.

An embodiment of the disclosure provides a computer-readable storage medium, having stored thereon a computer-executable instruction or a computer program that, when executed by a processor, causes the processor to implement operations comprising: acquiring a weight assigned to a free agent for a call task; acquiring call parameters for executing the call task during a first time period; determining a number of calls during a second time period based on the assigned weight and the call parameters, the first time period and the second time period being adjacent time periods; and executing the call task based on the number of calls and the assigned weight.

### BRIEF DESCRIPTION OF THE DRAWINGS

FIG. 1 is a schematic diagram of an application mode of a method for processing a call task according to an embodiment of the disclosure.

FIG. 2 is a schematic structural diagram of an electronic device according to an embodiment of the disclosure.

FIG. 3A is a first schematic flowchart of a method for processing a call task according to an embodiment of the disclosure.

FIG. 3B is a second schematic flowchart of a method for processing a call task according to an embodiment of the disclosure.

FIG. 3C is a third schematic flowchart of a method for processing a call task according to an embodiment of the disclosure.

FIG. 4 is a schematic flowchart of predicting a number of calls according to the related art.

FIG. 5 is a schematic flowchart of predicting a number of calls according to an embodiment of the disclosure.

It should be noted that the “first” and “second” above are only used to distinguish different solutions, and do not represent a degree of superiority or inferiority of the solutions, or a priority in the implementation procedure.

### DETAILED DESCRIPTION

To make the objectives, technical solutions, and advantages of the disclosure clearer, the disclosure will be described in further detail below with reference to the drawings. The described embodiments should not be regarded as limiting the disclosure. All other embodiments that are obtained by those of ordinary skill in the art without involving inventive skill shall fall within the scope of protection of the disclosure.

When the following description refers to “some embodiments”, said phrasing describes a subset of all possible embodiments, but it will be appreciated that “some embodiments” may be the same subset or different subsets of all possible embodiments, and may be combined with each other without conflict.

The term “first\second\third” as referred to in the following description is only to distinguish similar objects, and does not represent a specific ordering of the objects. It will be appreciated that the specific order or sequential order of the “first\second\third” may be interchanged if allowed, so that the embodiments of the disclosure described herein may be implemented in an order other than those illustrated or described herein.

In the embodiments of the disclosure, the relevant data collection and processing, when applied into instances, should strictly obtain informed consent or separate consent from a personal information subject according to the requirements of relevant laws and regulations, and subsequent data use and processing may be carried out within the scope of the laws and regulations and the authorization of the personal information subject.

In the embodiments of the disclosure, the term “module” or “unit” refers to a computer program or a part of a computer program that has a predetermined function, works together with other related parts to achieve a predetermined objective, and may be implemented in whole or in part by using software, hardware (such as a processing circuit or a memory), or a combination thereof. Similarly, one processor (or a plurality of processors or memories) may be used to implement one or more modules or units. Furthermore, each module or unit may be a part of an integral module or unit that includes the functionality of the module or unit.

Unless otherwise defined, all technical and scientific terms used in the embodiments of the disclosure have the same meanings as commonly understood by a person of ordinary skill in the technical field to which the disclosure belongs. The terms used in the embodiments of the disclosure are only for the purpose of describing the embodiments of the disclosure, and are not intended to limit the disclosure.

Before the embodiments of the disclosure are further described in detail, the nouns and terms referred to in the embodiments of the disclosure are illustrated. The nouns and terms referred to in the embodiments of the disclosure are applicable to the following explanations.
1) Agent: also referred to as a call center agent, a terminal agent, or a representative, generally composed of an agent computer, an agent software, an agent headset, a service personnel, etc. The agent implements related control functions by means of the agent software and a hardware device, to achieve the purpose of customer service.
2) Number of dialed calls: the total number of users who receive incoming calls.
3) Number of connections: the total number of users who are connected to the agents within 5 seconds.
4) Connection rate: a ratio of a number of connected calls to a number of calls that have been made.
5) Reach rate: a ratio of a number of users who are connected to calls to the total number of users.
6) Completion rate: a ratio of a number of called users to the total number of users.
7) Call task: a task in which a call center initiates a call to a user by means of an agent.
8) Assigned weight: a preconfigured probability for each agent to execute a call task, which is a value in the range of 0 to 1, and is a factor for determining a priority or importance based on which the call task is assigned to the agent. Factors that affect the assigned weight for the call task include a historical performance of the agent, a working period of the agent, etc.
9) Skill group: a group obtained by dividing service representatives based on service skills of the service representatives.

In the related art, a call center system predicts a number of calls based on a fixed number of dialed calls, that is, it determines a number of calls in an upcoming time period based on a number of users connected in a previous time period, resulting in situations in which there are either too many free agents or too many users hearing a hold music, thereby reducing the call efficiency and utilization rate of the agents. The agent dimension is not considered when predicting the number of calls, so that the accuracy of prediction of the number of calls is not high.

The embodiments of the disclosure provide a method and apparatus for processing a call task, a device, a computer-readable storage medium, and a computer program product, which can improve the efficiency of processing the call task.

An exemplary application of the electronic device provided by the embodiments of the disclosure will be described below. The electronic device provided by the embodiments of the disclosure may be implemented as various types of terminals, such as a notebook computer, a tablet computer, a desktop computer, a set-top box, a smart phone, a smart speaker, a smart watch, a smart television, or an in-vehicle terminal, or may be implemented as a server. An exemplary application of the device when implemented as a server will be described below.

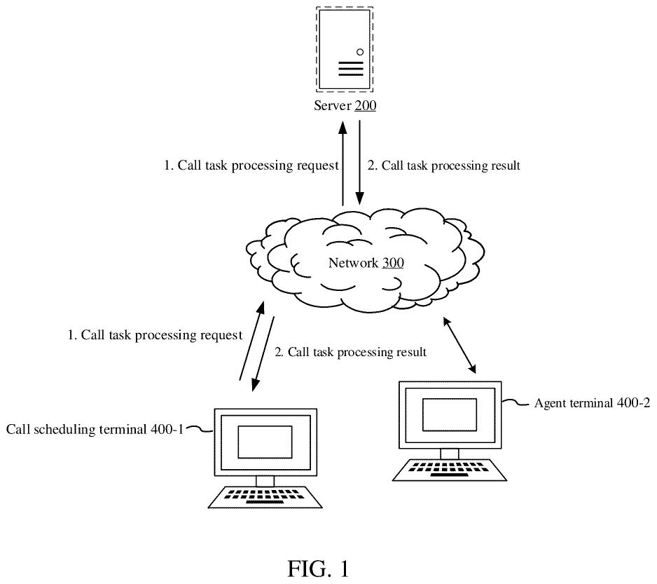

Referring to FIG. 1, FIG. 1 is a schematic diagram of an application mode of a method for processing a call task according to an embodiment of the disclosure. Illustratively, FIG. 1 relates to a server 200, a network 300, a call scheduling terminal 400-1, and an agent terminal 400-2 in a call center. The call scheduling terminal 400-1 and the agent terminal 400-2 are connected to the server 200 by means of the network 300. The network 300 may be a wide area network or a local area network, or a combination of the wide area network and the local area network.

In a process of processing a call task, illustratively, for the processing of a call task in a call center scenario, the call scheduling terminal 400-1 acquires the call task and sends a call task processing request to the server 200. The server 200, in response to the call task processing request, acquires a weight assigned to a free agent for the call task. Thereafter, the server acquires call parameters for executing the call task during a first time period, and determines a number of calls during a second time period based on the assigned weight and the call parameters. Further, the server executes the call task by using the agent terminal 400-2 corresponding to a free agent based on the number of calls and the assigned weight, to obtain a processing result of the call task, and outputs the processing result of the call task to the call scheduling terminal 400-1. The call scheduling terminal 400-1 receives and displays the processing result of the call task. In this way, the service representative may know the processing result of the call task in the call center by means of the call scheduling terminal 400-1.

In some embodiments, a server (e.g., the server 200) may be an independent physical server, or may be a server cluster or a distributed system composed of a plurality of physical servers, or may be a cloud server that provides a basic cloud computing service such as a cloud service, a cloud database, a cloud computing, a cloud function, a cloud storage, a network service, a cloud communication, a middleware service, a domain name service, a security service, a content delivery network (CDN), a big data, and an artificial intelligence platform. Each of the call scheduling terminal 400-1 and the agent terminal 400-2 may be, but is not limited to, a smartphone, a tablet computer, a laptop computer, a desktop computer, or the like. The terminal may be directly or indirectly connected to the server by means of wired or wireless communication, which is not limited in the embodiments of the disclosure.

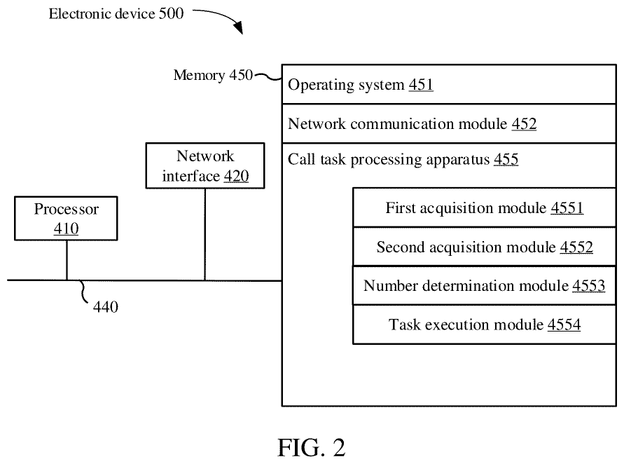

Referring to FIG. 2, FIG. 2 is a schematic structural diagram of an electronic device according to an embodiment of the disclosure. The electronic device may be a terminal or a server. The electronic device 500 shown in FIG. 2 includes: at least one processor 410, a memory 450, and at least one network interface 420. Various components in the electronic device 500 are coupled together by means of a bus system 440. It may be understood that the bus system 440 is used to implement connection and communication between these components. The bus system 440 includes a power supply bus, a control bus, and a status signal bus, in addition to a data bus. However, for the sake of clear illustration, the various buses are all designated as the bus system 440 in FIG. 2.

The processor 410 may be an integrated circuit chip having a signal processing capability, such as a general-purpose processor, a digital signal processor (DSP), or another programmable logic device, a discrete gate or transistor logic device, a discrete hardware component, or the like. The general-purpose processor may be a microprocessor, any conventional processor, or the like.

The memory 450 may be removable, non-removable, or a combination thereof. An exemplary hardware device includes a solid-state memory, a hard disk drive, an optical-disc drive, or the like. The memory 450 optionally includes one or more memory devices physically located remote from the processor 410.

The memory 450 includes a volatile memory or a nonvolatile memory, or may include both a volatile memory and a nonvolatile memory. The nonvolatile memory may be a read-only memory (ROM), and the volatile memory may be a random access memory (RAM). The memory 450 described in the embodiments of the disclosure is intended to include any suitable type of memory.

In some embodiments, the memory 450 can store data to support various operations. Examples of the data include programs, modules and data structures, or a subset or superset thereof, as exemplarily described below.

An operating system 451 includes a system program used to process various basic system services and execute hardware-related tasks, such as a framework layer, a core library layer, a driver layer, etc., and is used to implement various basic services and process hardware-based tasks.

A network communication module 452 is configured to access another electronic device via one or more (wired or wireless) network interfaces 420. An exemplary network interface 420 includes: Bluetooth, wireless compatibility certification (WiFi), a universal serial bus (USB), etc.

In some embodiments, the apparatus provided by the embodiments of the disclosure may be implemented by means of software. FIG. 2 shows an apparatus 455 for processing a call task stored in the memory 450, which may be software in the form of a program, a plug-in, or the like. The apparatus for processing a call task includes the following software modules: a first acquisition module 4551, a second acquisition module 4552, a number determination module 4553, and a task execution module 4554. These modules are logical modules, and may therefore be arbitrarily combined or further split according to the implemented functions. The function of each module will be described below.

The method for processing a call task provided by the embodiments of the disclosure will be described with reference to the exemplary application and implementation of the server device provided by the embodiments of the disclosure.

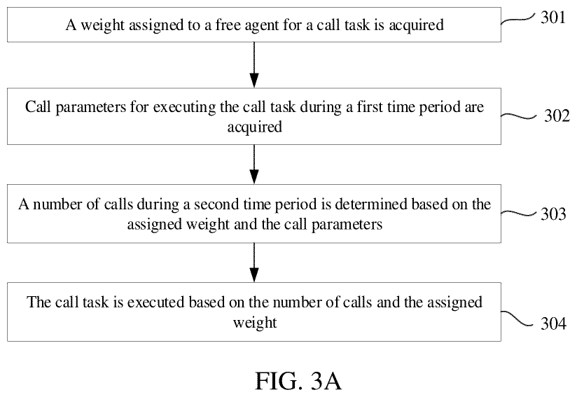

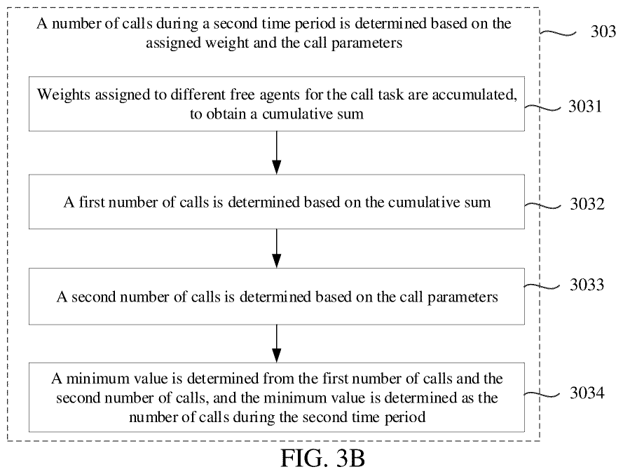

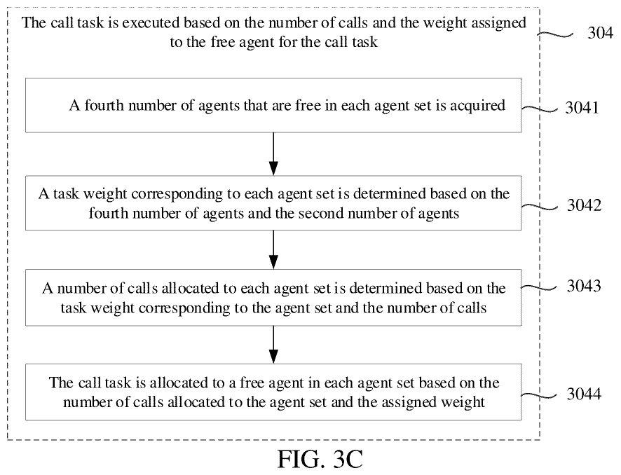

The method for processing a call task provided by the embodiments of the disclosure will be described below. As described previously, the electronic device for implementing the method for processing a call task in the embodiments of the disclosure may be a terminal, a server, or a combination thereof. Next, the method for processing a call task provided by the embodiments of the disclosure will be described using an example in which the electronic device is a server. Referring to FIG. 3A, FIG. 3A is a first schematic flowchart of a method for processing a call task according to an embodiment of the disclosure. The method will be described with reference to the operations shown in FIG. 3A.

In operation 301, a weight assigned to a free agent for a call task is acquired.

Here, the call task is a task for a call center to initiate a call to a user by means of an agent, and the call task may include different types of calling users and quantities of calls. A service representative use an agent to execute the call task, and the weight assigned to each agent for the call task is a preconfigured probability for each agent to execute the call task, which is a value in the range of 0 to 1. The weight assigned to each agent for the call task is usually determined based on a series of factors, such as a historical performance of the agent, e.g. a problem solving rate, a customer satisfaction score, etc. The historical performance of the agents is divided into different performance levels, and each performance level corresponds to a respective weight range. The weight assigned to the agent for the call task may be a random value acquired from the weight range corresponding to the performance level of the agent. Illustratively, the performance levels include a low level, a medium level, and a high level. The weight range corresponding to the low level may be 0.1 to 0.3, the weight range corresponding to the medium level may be 0.4 to 0.7, and the weight range corresponding to the high level may be 0.8 to 1. When the performance level of a free agent is the high level, a random value from 0.8 to 1 may be determined as the weight assigned to the free agent, e.g., the assigned weight may be 0.9. The agents may also be divided into different efficiency levels in an efficiency index dimension based on call durations, processing speeds, etc., of the agents. Similarly, each efficiency level corresponds to a respective weight range, and the weight assigned to the agent for the call task may be a random value acquired from the weight range corresponding to the efficiency level of the agent. In some embodiments, a comprehensive level may also be determined based on the efficiency level and the performance level of the agent. For example, the higher level among the efficiency level and the performance level may be determined to be the comprehensive level, or the lower level among the efficiency level and the performance level may be determined to be the comprehensive level, or the efficiency level and the performance level may be averaged to obtain the comprehensive level. Each comprehensive level corresponds to a respective weight range, and the weight assigned to the agent for the call task may be a random value acquired from the weight range corresponding to the comprehensive level of the agent.

In some embodiments, a mapping relationship between at least one factor that affects the historical performance of the agent and the weight assigned to the agent for the call task may be created, and a mapping function may be defined to represent the mapping relationship. The mapping function may be a linear function or a non-linear function, and a factor value corresponding to the at least one factor that affects the historical performance of the agent is used as input data of the mapping function, to determine the weight assigned to the agent for the call task in the historical performance dimension. Alternatively, the mapping relationship is fitted by using a machine learning model, and the factor value corresponding to the at least one factor that affects the historical performance of the agent and the weight assigned to the agent for the call task are used as samples to train the machine learning model, to obtain a trained machine learning model. The weight assigned to the agent for the call task in the historical performance dimension is determined by using the trained machine learning model and the factor value corresponding to the at least one factor that affects the historical performance of the agent.

The weight assigned to a free agent for the call task refers to the weight assigned to an agent that is in a free state and has not executed the call task. For example, the call task is to make 100 phone calls, and agent 1, agent 2, and agent 3 are specified to execute the call task. The weight assigned to the agent 1 for the call task is 0.1, the weight assigned to the agent 2 for the call task is 0.5, and the weight assigned to the agent 3 for the call task is 0.4. If the agent 3 is in the free state, the weight assigned to the free agent for the call task is 0.4.

In operation 302, call parameters for executing the call task during a first time period are acquired.

Here, a total number of calls that need to be executed for the call task is determined, and the time of day is divided into a plurality of time periods having the same duration. The time period may be a second-level time period, a minute-level time period, or an hour-level time period. The call task is started to be executed from the first time period. A call task with a preset number of calls is first selected from a plurality of call tasks as the call task to be executed during the first time period, and the preset number of calls is less than a total number of calls. After 3-5 seconds of executing the call task during the first time period, events such as call ringing and call answering occur, whereby call parameters for executing the call task during the first time period are acquired. The call parameters refer to various call parameters involved in the process of making a phone call. After the execution of the call task during each time period is completed, the call task during the next time period starts to be executed, and the call parameters for executing the call task during the previous time period may be acquired during the next time period.

The call parameters may include a number of calls that have been made, a number of calls that have been connected, a number of calls that have been hung up, a time in call, etc. The number of calls that have been made is a number of phone calls that have already been dialed out, the number of calls that have been connected is a number of phone calls that have been connected, the number of calls that have been hung up is a number of phone calls that are hung up after the call was connected for 1 second, and the time in call is a duration from a phone call being connected to the phone call ending.

Illustratively, a call task of making 100 phone calls is used as an example, i.e., the total number of calls that need to be performed by the call task is 100. The time of day is divided into a plurality of time periods, each time period lasts 5 minutes, 10 phone calls are selected from among the 100 phone calls as a call task to be executed during the first time period, and the call parameters for executing the call task during the first time period are acquired after the call task is executed within the 5-minute time period for 3-5 seconds. After the execution of the call task during each 5-minute time period is completed, the execution of the call task for the next 5-minute time period is started.

In operation 303, a number of calls during a second time period is determined based on the assigned weight and the call parameters.

Here, the first time period and the second time period are adjacent time periods, and the first time period precedes the second time period. A number of calls corresponding to the call task to be executed during the second time period is determined based on the weight assigned to the free agent for the call task during the second time period and the call parameters for executing the call task during the first time period. The second time period has the same duration as the first time period.

In some embodiments, referring to FIG. 3B, FIG. 3B is a second schematic flowchart of a method for processing a call task according to an embodiment of the disclosure. The operation 303 shown in FIG. 3A may be implemented by operations 3031 to 3034 in FIG. 3B, which will be specifically described below.

In operation 3031, weights assigned to different free agents for the call task are accumulated, to obtain a cumulative sum.

The weights assigned to different free agents for the call task are determined, and the weights assigned to all of the free agents for the call task are added, to obtain a cumulative sum of the weights assigned to all of the free agents for the call task.

Illustratively, the execution of the call task by agent 1, agent 2, and agent 3 is used as an example, the weight assigned to the agent 1 for the call task is determined to be 0.1, the weight assigned to the agent 2 for the call task is determined to be 0.5, and the weight assigned to the agent 3 for the call task is determined to be 0.4. If the agent 1 and the agent 2 are in the free state, the weight assigned to the agent 1 for the call task and the weight assigned to the agent 2 for the call task are added, and the cumulative sum of the weights assigned to all of the free agents for the call task is 0.6.

In operation 3032, a first number of calls is determined based on the cumulative sum.

Here, the first number of calls is a number of calls corresponding to the call task to be executed during the second time period, which is predicted in a dimension of a task weight assigned to the agent. The cumulative sum of the weights assigned to all of the free agents for the call task is rounded up, to obtain the first number of calls.

Illustratively, the execution of the call task by agent 1, agent 2, and agent 3 is used as an example, the weight assigned to the agent 1 for the call task is 0.1, the weight assigned to the agent 2 for the call task is 0.5, and the weight assigned to the agent 3 for the call task is 0.4. If the agent 1 and the agent 2 are in the free state, the weight assigned to the agent 1 for the call task and the weight assigned to the agent 2 for the call task are added, and the cumulative sum of the weights assigned to all of the free agents for the call task is 0.6. The cumulative sum is rounded up to obtain the first number of calls to be 1.

In the embodiments of the disclosure, the first number of calls is determined based on the cumulative sum of the weights assigned to all of the free agents for the call task, and the first number of calls can be predicted in a dimension of a task weight assigned to the agent, thereby improving the accuracy of prediction of the first number of calls.

In operation 3033, a second number of calls is determined based on the call parameters.

Here, the second number of calls is a number of calls corresponding to the call task to be executed during the second time period, which is predicted in a dimension of a phone call parameter. The second number of calls for the call task to be executed during the second time period is calculated based on the call parameters for executing the call task during the first time period.

In some embodiments, the call parameters include: a number of calls that have been made, a number of calls that have been connected, a number of calls that have been hung up, an time in progress for a hit, and a service time. The second number of calls may be determined based on the call parameters by performing the following operations: acquiring a number of calls in progress, a first number of agents in a call state, a second number of agents that are free, and a third number of agents in a post operation state; determining a connection success rate based on the number of calls that have been made and the number of calls that have been connected, and determining a predicted number of connections based on the number of calls in progress and the connection success rate; determining a first predicted value based on the service time, the time in progress for a hit, and the first number of agents; determining a call abandonment rate based on the number of calls that have been connected and the number of calls that have been hung up, and determining a predicted connection success rate based on the call abandonment rate and the connection success rate; and determining the second number of calls based on the second number of agents, the third number of agents, the predicted number of connections, the first predicted value, and the predicted connection success rate.

The number of calls that have been made and the number of calls that have been connected for the call task executed during the first time period are acquired, and a ratio of the number of calls that have been connected to the number of calls that have been made is calculated to determine the connection success rate. Illustratively, the connection success rate may be determined by the following formula (1):

$$SR = NCC / NOC \qquad ( 1 )$$

where SR represents the connection success rate, NCC represents the number of calls that have been connected, and NOC represents the number of calls that have been made.

In some embodiments, the number of calls in progress for the call task executed during the first time period is acquired, and the predicted number of connections is determined based on the product of the number of calls in progress and the connection success rate. Illustratively, the predicted number of connections may be determined by the following formula (2):

$$PNC = NC * SR \qquad ( 2 )$$

where PNC represents the predicted number of connections, NC represents the number of calls in progress, and SR represents the connection success rate.

A time in call of each call, a time in post operation of each call, a call ringing time of each call, a call connection time of each call, and a first number of agents in a call state, for the call task executed during the first time period are acquired. The time in post operation is a preset time of 0 to 100 seconds after the call ends. The time in call of each call and the time in post operation of each call are added to obtain the service time. The call ringing time of each call is subtracted from the call connection time of each call to obtain a ringing duration of each call, and the ringing duration of each call is cumulated, to obtain a cumulative sum of call ringing durations. The cumulative sum of call ringing durations is divided by the number of calls that have been made, to obtain a time in progress for a hit. Illustratively, the time in progress for a hit may be determined by the following formula (3):

$$TR = SCR / NOC \qquad ( 3 )$$

where TR represents the time in progress for a hit, NOC represents the number of calls that have been made, and SCR represents the cumulative sum of call ringing durations.

The first predicted value is calculated based on the service time, the time in progress for a hit, and the first number of agents. Illustratively, the first predicted value may be determined by the following formula (4):

$$FPV = AC * ( 1 - e \hat{} ( - TR / TC ) ) \qquad ( 4 )$$

where FPV represents the first predicted value, AC represents the first number of agents, and TC represents the service time.

The number of calls that have been hung up is a number of calls that are actively hung up by users within 1 second after the calls are connected. The number of calls that have been hung up for the call task executed during the first time period is acquired, and the number of calls that have been hung up is divided by the number of calls that have been connected to calculate the call abandonment rate. Illustratively, the call abandonment rate may be determined by the following formula (5):

$$UR = NDC / NCC \qquad ( 5 )$$

where UR represents the call abandonment rate, NDC represents the number of calls that have been hung up, and NCC represents the number of calls that have been connected.

The predicted connection success rate is calculated by multiplying the call abandonment rate by the connection success rate. Illustratively, the predicted connection success rate may be determined by the following formula (6):

$$PCS = UR * SR \qquad ( 6 )$$

where PCS represents the predicted connection success rate, UR represents the call abandonment rate, and SR represents the connection success rate.

In the embodiments of the disclosure, the second number of calls is calculated based on the call parameters such as the number of calls that have been made, the number of calls that have been connected, the number of calls that have been hung up, the time in progress for a hit, and the service time, so that the second number of calls can be predicted in a dimension of the call parameter, and the accuracy of predicting the second number of calls is improved.

In some embodiments, the second number of calls may be determined based on the second number of agents, the third number of agents, the predicted number of connections, the first predicted value, and the predicted connection success rate, by performing the following operations: determining a difference between the second number of agents and the predicted number of connections as a number of free agents; determining a sum of the number of free agents, the first predicted value, and the third number of agents as a candidate number of calls; adjusting the candidate number of calls by using a preset adjustment coefficient, to obtain a predicted number of calls; and determining the second number of calls based on the predicted number of calls and the predicted connection success rate.

The second number of agents that are free and the third number of agents in the post operation state for the call task executed during the first time period are acquired, the difference between the second number of agents and the predicted number of connections is calculated, and the difference is determined as the number of free agents. The sum of the number of free agents, the first predicted value, and the third number of agents is calculated, and the sum of the three is determined as the candidate number of calls. The preset adjustment coefficient is a value in the range of 0 to 100, and the preset adjustment coefficient is multiplied by the candidate number of calls to obtain the predicted number of calls. The predicted number of calls is divided by the predicted connection success rate, and the division result is rounded up to obtain the second number of calls. Illustratively, the second number of calls may be determined by the following formula (7):

$$NSC = FA - NC * SR + AC * ( 1 - e \hat{} ( - TR / TC ) ) + AP ) * MAP / ( UR * SR ) \qquad ( 7 )$$

where NSC represents the second number of calls, FA represents the second number of agents, NC represents the number of calls in progress, SR represents the connection success rate, AC represents the first number of agents, TR represents the time in progress for a hit, TC represents the service time, AP represents the third number of agents, MAP represents the adjustment coefficient, and UR represents the call abandonment rate.

In the embodiments of the disclosure, the second number of calls is determined based on the second number of agents, the third number of agents, the predicted number of connections, the first predicted value, and the predicted connection success rate, so that the second number of calls can be calculated in view of a plurality of call parameters, and the accuracy of calculating the second number of calls is improved.

With continued reference to FIG. 3B, in operation 3034, a minimum value is determined from the first number of calls and the second number of calls, and the minimum value is determined as the number of calls during the second time period.

Here, the minimum value is determined from the first number of calls and the second number of calls, and the minimum value is used as the number of calls corresponding to the call task to be executed during the second time period. Illustratively, the number of calls during the second time period may be determined by the following formula (8):

$$OCP = min ( NFC , NSC ) \qquad ( 8 )$$

where OCP represents the number of calls during the second time period, NFC represents the first number of calls, and NSC represents the second number of calls.

In the embodiments of the disclosure, the number of calls during the second time period is determined based on the weight assigned to the free agent for the call task and the call parameters, and the minimum value among the first number of calls and the second number of calls is determined as the number of calls during the second time period, which takes into account both the dimensions of the task weight assigned to the agent and the call parameter, thereby improving the accuracy of prediction of the number of calls during the second time period.

With continued reference to FIG. 3A, in operation 304, the call task is executed based on the number of calls and the assigned weight.

Here, the call task during the second time period is executed based on the number of calls during the second time period and the weight assigned to the free agent for the call task.

In some embodiments, the call task corresponds to a plurality of agent sets. Referring to FIG. 3C, FIG. 3C is a third schematic flowchart of a method for processing a call task according to an embodiment of the disclosure. The operation 304 shown in FIG. 3A may be implemented by means of operations 3041 to 3044 in FIG. 3C, which will be specifically described below.

In operation 3041, a fourth number of agents that are free in each agent set is acquired.

Here, at least one agent set is configured for the call task. The agent set, also known as a skill group, is obtained by dividing service representatives based on service skills of the service representatives. A preset number of service representatives are configured in each agent set, and each agent set may process one call task or a plurality of call tasks. Each agent set is further configured with a preset number of agents, and the weight assigned to each agent in the agent set for the call task. The fourth number of agents is a number of free agents in each agent set corresponding to the call task, and the number of free agents in each agent set corresponding to the call task is acquired. Illustratively, the execution of the call task by agent set 1 and agent set 2 is used as an example, agent 1, agent 2, and agent 3 are configured in the agent set 1, and if the agent 1 and the agent 2 are in the free state, the fourth number of agents that are free in the agent set 1 is 2. Agent 4, agent 5, and agent 6 are configured in the agent set 2, and if the agent 6 is in the free state, the fourth number of agents that are free in the agent set 2 is 1.

In operation 3042, a task weight corresponding to each agent set is determined based on the fourth number of agents and the second number of agents.

In some embodiments, the task weight corresponding to each agent set during the second time period is determined based on the fourth number of agents that are free in each agent set during the second time period and the second number of agents that are free for executing the call task during the second time period. The fourth number of agents in each agent set is divided by the second number of agents, and the obtained ratio result is determined as the task weight corresponding to each agent set.

Illustratively, the execution of the call task by the agent set 1 and the agent set 2 is used as an example, if the fourth number of agents that are free in the agent set 1 is 2, the fourth number of agents that are free in the agent set 2 is 1, and the second number of agents that are free for executing the call task during the second time period is 3, the task weight corresponding to the agent set 1 during the second time period is ⅔, and the task weight corresponding to the agent set 2 is ⅓.

In operation 3043, the number of calls allocated to each agent set is determined based on the task weight corresponding to the agent set and the number of calls.

The task weight corresponding to each agent set is multiplied by the number of calls corresponding to the second time period, and the obtained product is rounded to determine the number of calls allocated to each agent set.

Illustratively, the execution of the call task by the agent set 1 and the agent set 2 is used as an example, if the number of calls corresponding to the second time period is 30, the task weight corresponding to the agent set 1 during the second time period is ⅔, and the task weight corresponding to the agent set 2 is ⅓, the number of calls allocated to the agent set 1 during the second time period is 20, and the number of calls allocated to the agent set 2 during the second time period is 10.

In operation 3044, the call task is allocated to a free agent in each agent set based on the number of calls allocated to the agent set and the assigned weight.

After the number of calls allocated to each agent set during the second time period and the weight assigned to the free agent in each agent set for the call task are determined, for the free agents in each agent set, the weights assigned to the free agents for the call task are added, to obtain an assigned weight addition result. A ratio of the weight assigned to each free agent for the call task to the assigned weight addition result is calculated, to obtain an assignment proportion of a number of calls for each free agent. The number of calls allocated to each agent set during the second time period is multiplied by the assignment proportion of the number of calls, to obtain a number of calls allocated to each free agent. At this time, the number of calls allocated to each free agent may also be adjusted based on the weight assigned to the free agent for the call task.

Illustratively, the number of calls allocated to the agent set 1 during the second time period is 100, the agent 1 and the agent 2 in the agent set 1 are in a free state, the weight assigned to the agent 1 for the call task is 0.6, and the weight assigned to the agent 2 for the call task is 0.5. The weights assigned to the free agents for the call task are added to obtain the assigned weight addition result, and the assigned weight addition result is 1.1. The assignment proportion of the number of calls to the agent 1 is 6/11, and the assignment proportion of the number of calls to the agent 2 is 5/11. The number of calls, which is 100, is multiplied by the assignment proportion of the number of calls to obtain the number of calls allocated to each free agent, which is about 50. Since the weight assigned to the agent 1 for the call task is greater than the weight assigned to the agent 2 for the call task, the number of calls allocated to each free agent is adjusted. The number of calls allocated to the agent 1 may be 60, and the number of calls allocated to the agent 2 may be 40. If there are 20 service representatives in the agent set 1, one service representative in the agent set 1 may be specified to execute a call task allocated to the agent 1, and another service representative in the agent set 1 may be specified to execute a call task allocated to the agent 2, based on the skill experience of the service representative.

In the embodiments of the disclosure, a call task is allocated to a free agent in the agent set based on the number of calls allocated to the agent set and the weight assigned to the free agent in the agent set for the call task, which can improve the utilization rate of the agents, and the efficiency of processing the call task can be improved.

In some embodiments, the following operations may be performed. When at least two call tasks are allocated to a free agent, one call task may be randomly determined from the at least two call tasks as a target call task for the free agent; or a weight assigned to the free agent for each of the at least two call tasks may be acquired, and a call task having the highest assigned weight may be determined as the target call task for the free agent.

Here, the target call task is a call task executed by a free agent in each agent set during the second time period. Since two or more call tasks may be allocated to one agent set, at least two call tasks may be allocated to a free agent in the agent set. When at least two call tasks are allocated to a free agent in each agent set, one call task may be randomly determined from the two call tasks as the call task to be executed by the free agent in each agent set during the second time period. The weight assigned to a free agent for each call task may also be acquired, and the call task having the highest assigned weight is determined as the call task to be executed by the free agent in each agent set during the second time period.

Illustratively, call task 1 and call task 2 are allocated to the agent set 1, and the agent 1 and the agent 2 in the agent set 1 are in a free state. The weight assigned to the agent 1 for the call task 1 is 0.6, the weight assigned to the agent 1 for the call task 2 is 0.4, the weight assigned to the agent 2 for the call task 1 is 0.4, and the weight assigned to the agent 2 for the call task 2 is 0.6. The agent 1 and the agent 2 may each randomly determine a call task from the call task 1 and the call task 2 as a call task to be executed during the second time period. Alternatively, it is determined that the weight assigned to the agent 1 for the call task 1 is highest, and the call task 1 is determined as the call task to be executed by the agent 1 during the second time period. It is determined that the weight assigned to the agent 2 for the call task 2 is highest, and the call task 2 is determined as the call task to be executed by the agent 2 during the second time period.

In the embodiments of the disclosure, when at least two call tasks are allocated to a free agent, a call task may be randomly determined as a target call task, or the call task having the highest task weight assigned to the free agent may be determined as the target call task, so that the free agent can select to process different call tasks, which improves the utilization rate of the agents, and improves the efficiency of processing the call tasks.

In some embodiments, before the operation 301 shown in FIG. 3A is performed, the following operations may be performed to determine the weight assigned to the agent in the agent set for the call task. For each agent, at least one agent set to which the agent belongs is acquired, and a target call task allocated to the agent set is acquired. A weight assigned to each agent, for the target call task, in the agent set to which the agent belongs is determined.

Each agent may be configured in a plurality of agent sets, at least one agent set to which each agent belongs is acquired, and the target call task allocated to the agent set is acquired. The weight assigned to each free agent, for the target call task, in the agent set to which the free agent belongs is determined based on the weight assigned to each agent, for the target call task, in the agent set to which the agent belongs, to execute the target call task, which is a cross-modality cross strategy for the agents.

Illustratively, the target call task is task 1, and the execution of the call task 1 by agent set 1 and agent set 2 is used as an example, agent 1, agent 2, and agent 3 are configured in the agent set 1, and the agent 1 and the agent 2 are in the free state. The weight assigned to the agent 1 for the call task 1 is 0.1, the weight assigned to the agent 2 for the call task 1 is 0.5, and the weight assigned to the agent 3 for the call task 1 is 0.4. The call task 1 is executed based on the weights assigned to the agent 1 and the agent 2 in the agent set 1 for the call task 1. The agent 2 and the agent 3 are configured in the agent set 2, and the agent 3 is in the free state. The weight assigned to the agent 2 for the call task 1 is 0.3, and the weight assigned to the agent 3 for the call task 1 is 0.7. The call task 1 is executed based on the weight assigned to the agent 3 in the agent set 2 for the call task 1.

In the embodiments of the disclosure, for at least one agent set to which each agent belongs, the target call task is executed based on the target call task allocated to the agent set and the weight assigned to each agent, for the target call task, in the agent set to which the agent belongs, so that the same agent can execute the call tasks in different agent sets, thereby improving the efficiency of processing the tasks.

In some embodiments, the method for processing a call task provided by the embodiments of the disclosure may be applied to the field of cloud technology. The weight assigned to the free agent for the call task is acquired on a cloud platform, the call parameters for executing the call task during the first time period are acquired, and the number of calls during the second time period is determined based on the assigned weight and the call parameters, the first time period and the second time period being adjacent time periods. Further, the call task is executed based on the number of calls and the assigned weight. In this way, a cloud server determines the number of calls during the second time period by combining the weight assigned to the free agent for the call task and the call parameters for executing the call task during the first time period, and the number of calls is predicted by taking into account both the dimensions of the task weight assigned to the agent and the call parameter, thereby improving the accuracy of prediction of the number of calls. The cloud server can allocate a free agent to execute the call task by means of the number of calls and the weight assigned to the free agent for the call task, so as to avoid a situation in which there are too many free agents, and the utilization rate of the agents and the efficiency of processing the call tasks are improved.

By applying the described embodiments of the disclosure, the weight assigned to the free agent for the call task is acquired, the call parameters for executing the call task during the first time period are acquired, and then, the number of calls during the second time period is determined based on the assigned weight and the call parameters, the first time period and the second time period being adjacent time period. Further, the call task is executed based on the number of calls and the assigned weight. In this way, the number of calls during the second time period is determined by combining the weight assigned to the free agent for the call task and the call parameters for executing the call task during the first time period, and the number of calls is predicted by taking into account both the dimensions of the task weight assigned to the agent and the call parameter, thereby improving the accuracy of predicting the number of calls. The accurate prediction of the number of calls provides a strategic support for the operation management of the call center, and call resources can be optimally configured for the call center system based on the predicted number of calls, thereby ensuring a stable operation of the system, and avoiding a system crash caused by traffic surges, in which case the user has to wait for too long time, and user experience is affected. By means of the number of calls and the weight assigned to the free agent for the call task, a free agent can be allocated to execute the call task, so as to avoid a situation in which there are too many free agents, and the utilization rate of the agents and the efficiency of processing the call tasks are improved.

An exemplary application of the method for processing a call task provided by the embodiments of the disclosure to a scenario in which a call center predicts a number of calls will be described below.

A call center is a relatively centralized place, and is a service organization composed of a group of service personnel. The call center usually uses computer communication technology to process phone consultations from enterprises and users, may automatically allocate an incoming call to an operator having a corresponding skill for processing, and may record and store the information of all incoming calls. The call center may have both the incoming call and outgoing call functions, for example, the call center may process services such as information querying and consultation from the users, and may also perform outgoing call services, such as a user follow up and a satisfaction survey.

The call center makes a certain number of phone calls to users based on requirements every day, and the calls are made through agents. Each call needs to be outputted to an operator. The operator submits connected signaling with the call center, and the call center receives the signaling and converts the signaling into a corresponding event. The events form the states of the agents, for example: eating, meeting, resting, etc. Ideally, if an agent in the call center keeps receiving calls during working hours (although a call is made, since the system automatically makes the call, it is perceived by the agent in the call center that the call is being answered), the state of the agent will cycle through the state transitions: “ready”—“in call”—“post operation (a fixed number X of seconds)”—“ready”—“ . . . ”. Only the agent in the ready state can receive a new call. If the number of calls concurrently made by the call center in a batch is too large, the number of users dialing at the same time may be greater than the number of agents in the ready state. At this time, some users will hear the hold voice of “please hold . . . ”. If the number of calls concurrently made by the call center in a batch is too small, the number of users dialing at the same time may be less than the number of agents in the ready state. At this time, some agents are still in the ready state, and the agents in the ready state are free agents.

In the related art, the call center system predicts the number of calls based on a fixed number of dialed calls, but does not consider human factors or weights to efficiently predict the number of calls in a relatively uniform standard, reduce the number of users who hear the hold voice of “please hold . . . ” while reducing the number of free agents, and improve the utilization rate of the agents. The following problems exist in the process of predicting the number of calls by the call center.
1) The number of calls in the next time period is determined based on the number of users connected in the previous time period, resulting in situations in which there are either too many free agents or too many users hearing hold tones, thereby reducing the call efficiency and utilization rate of the agents.
2) The agent dimension is not considered when predicting the number of calls, so that the accuracy of prediction of the number of calls is not high.

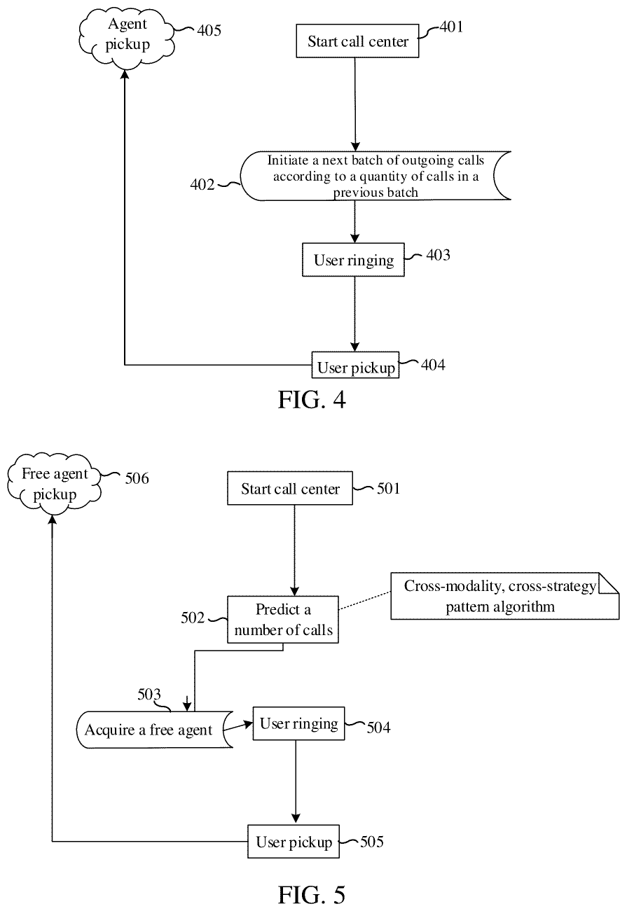

Illustratively, referring to FIG. 4, FIG. 4 is a schematic flowchart of predicting a number of calls according to the related art. In operation 401, a call center is started. In operation 402, a next batch of outgoing calls is initiated based on a number of calls in a previous batch. In operation 403, user-side ringing occurs. In operation 404, user pickup occurs. In operation 405, agent pickup occurs.

In view of the problems in the related art, the embodiments of the disclosure provide a method for processing a call task, which includes the following improvements compared with the related art.

A dimension of a task weight assigned to the agent is added, and the index of the real effective output of the agent is used as an assessment index to predict the number of calls. That is, one agent may be allocated to a plurality of skill groups (i.e., agent sets), and the same agent may execute a plurality of call tasks, which is helpful for improving an overall call connection volume.

The embodiments of the disclosure may be applied to various types of call scenarios, such as a call center background service in which a call center system makes a predicted number of calls each time to contact users or virtual robots, or an interactive voice response system.

Illustratively, at 7:00 am every morning, the call center system stores into a service database a number of calls that need to be dialed during the day. One day includes a plurality of time periods. The number of calls that need to be dialed on the day is the total number of calls in the plurality of time periods of one day, and the number of calls is allocated based on the total number of people in the skill group, for example, skill group 1 has 50 people and skill group 2 has 30 people. A list of call tasks is created. For example, call task 1 is to make 50,000 calls, and call task 2 is to make 100,000 calls. The skill group 1 and skill group 2 may be specified to execute the call task 1, and a task weight assigned to each agent in the corresponding skill group is also configured. For example, the task weight assigned to the agent 1 in the skill group 1 for the call task 1 is 0.4, and the task weight assigned to the agent 1 in the skill group 2 for the call task 1 is 0.6.

Illustratively, the 100,000 calls in the call task 2 may be automatically made by the call center system. The 100,000 calls may not need to be completed, and if the calls are not completed, it is possible to consider making adjustments such as increasing the number of people in the skill group or the time of the day to make calls. When a phone call is sent to an operator during the call process, events such as call triggering, ringing, pickup, and rejection will occur. A collection of events in 3-5 seconds will be accumulated, and the number of calls in the next time period in each call task is calculated based on a cross-modality, cross-strategy pattern algorithm, namely, a formula for predicting the number of calls.

Illustratively, the predicted number of calls may be determined by the following formula (8):

$$OCP = min ( NFC , NSC ) \qquad ( 8 )$$

where OCP represents the predicted number of calls, NFC represents the first number of calls, and NSC represents the second number of calls. The first number of calls is a cumulative sum of the task weights assigned to the free agents for the call task.

Illustratively, the skill group 1 is specified to execute the call task 1, the agent 1, the agent 2, and the agent 3 are configured in the skill group 1, the weight assigned to the agent 1 for the call task 1 is 1, the weight assigned to the agent 2 for the call task 1 is 0.5, and the weight assigned to the agent 3 for the call task 1 is 0.5. If the agent 1, the agent 2, and the agent 3 are all free agents, the cumulative sum of the task weights assigned to the free agents for the call task 1 is 2. If the agent 3 is a free agent, the cumulative sum of the task weights assigned to the free agents for the call task 1 is 0.5.

Illustratively, the second number of calls may be determined by the following formula (7):

$$NSC = FA - NC * SR + AC * ( 1 - e \hat{} ( - TR / TC ) ) + AP ) * MAP / ( UR * SR ) \qquad ( 7 )$$

where NSC represents the second number of calls, FA represents the second number of agents, NC represents the number of calls in progress, SR represents the connection success rate, AC represents the first number of agents, TR represents the time in progress for a hit, TC represents the service time, AP represents the third number of agents, MAP represents the adjustment coefficient, and UR represents the call abandonment rate.

The information of the free agents may be uploaded to a calling platform, and the number of free agents is a number of agents in the free state that can actually and effectively communicate with users directly. The adjustment coefficient is a value in the range of 0 to 100, the service time includes a time in call and a time in post operation, and the time in post operation is a uniformly configured time of 0 to 100 seconds for each skill group.

Illustratively, the connection success rate may be determined by the following formula (1):

$$SR = NCC / NOC \qquad ( 1 )$$

where SR represents the connection success rate, NCC represents the number of calls that have been connected, and NOC represents the number of calls that have been made.

Illustratively, the call abandonment rate may be determined by the following formula (5):

$$UR = NDC / NCC \qquad ( 5 )$$

where UR represents the call abandonment rate, NDC represents the number of calls that have been hung up, and NCC represents the number of calls that have been connected.

Illustratively, the time in progress for a hit may be determined by the following formula (3):

$$TR = SCR / NOC \qquad ( 3 )$$

where TR represents the time in progress for a hit, NOC represents the number of calls that have been made, and SCR represents the cumulative sum of call ringing durations.

Illustratively, referring to FIG. 5, FIG. 5 is a schematic flowchart of predicting a number of calls according to an embodiment of the disclosure. In operation 501, a call center is started. In operation 502, the number of calls is predicted, and the number of calls is predicted by using a cross-modality, cross-strategy pattern algorithm. In operation 503, a free agent is acquired. In operation 504, user-side ringing occurs. In operation 505, user pickup occurs. In operation 506, agent pickup occurs.

In the above application scenario in which the call center predicts the number of calls, the number of calls is predicted by the cross-modality, cross-strategy pattern algorithm, and the number of free agents is reduced by taking into account different call tasks and the task weights assigned to the agents, thereby improving the connection rate and utilization rate of the agents and improving user experience.

An exemplary structure of an apparatus 455 for processing a call task according to an embodiment of the disclosure, which is implemented as software modules, will be described below. In some embodiments, as shown in FIG. 2, the software modules of the apparatus 455 for processing a call task stored in the memory 450 may include: a first acquisition module 4551, configured to acquire a weight assigned to a free agent for a call task; a second acquisition module 4552, configured to acquire call parameters for executing the call task during a first time period; a number determination module 4553, configured to determine a number of calls during a second time period based on the assigned weight and the call parameters, the first time period and the second time period being adjacent time periods; and a task execution module 4554, configured to execute the call task based on the number of calls and the assigned weight.

In some embodiments, the number determination module 4553 is further configured to: accumulate the weights assigned to different free agents for the call task, to obtain a cumulative sum; determine a first number of calls based on the cumulative sum; determine a second number of calls based on the call parameters; and determine a minimum value among the first number of calls and the second number of calls, and determine the minimum value as the number of calls during the second time period.

In some embodiments, the call parameters include: a number of calls that have been made, a number of calls that have been connected, a number of calls that have been hung up, a time in progress for a hit, and a service time. The number determination module 4553 is further configured to: acquire a number of calls in progress, a first number of agents in a call state, a second number of agents that are free, and a third number of agents in a post operation state; determine a connection success rate based on the number of calls that have been made and the number of calls that have been connected, and determine a predicted number of connections based on the number of calls in progress and the connection success rate; determine a first predicted value based on the service time, the time in progress for a hit, and the first number of agents; determine a call abandonment rate based on the number of calls that have been connected and the number of calls that have been hung up, and determine a predicted connection success rate based on the call abandonment rate and the connection success rate; and determine the second number of calls based on the second number of agents, the third number of agents, the predicted number of connections, the first predicted value, and the predicted connection success rate.

In some embodiments, the number determination module 4553 is further configured to: determine a difference between the second number of agents and the predicted number of connections as a number of free agents; determine a sum of the number of free agents, the first predicted value, and the third number of agents as a candidate number of calls; adjust the candidate number of calls by using a preset adjustment coefficient, to obtain a predicted number of calls; and determine the second number of calls based on the predicted number of calls and the predicted connection success rate.

In some embodiments, the call task corresponds to a plurality of agent sets, and the task execution module 4554 is further configured to: acquire a fourth number of agents that are free in each agent set; determine a task weight corresponding to each agent set based on the fourth number of agents and the second number of agents; determine, based on the task weight corresponding to each agent set and the number of calls, a number of calls allocated to each agent set; and allocate the call task to a free agent in each agent set based on the number of calls allocated to the agent set and the assigned weight.

In some embodiments, the task execution module 4554 is further configured to: when at least two call tasks are allocated to a free agent, randomly determine a call task from the at least two call tasks as a target call task for the free agent; or acquire a weight assigned to the free agent for each of the at least two call tasks, and determine a call task having the highest assigned weight as the target call task for the free agent.

The embodiments of the disclosure provide a computer program product, including a computer-executable instruction or a computer program stored in a computer-readable storage medium. A processor of an electronic device reads the computer-executable instruction or the computer program from the computer-readable storage medium, and the processor executes the computer-executable instruction or the computer program, to cause the electronic device to perform the method for processing a call task described above in the embodiments of the disclosure.

The embodiments of the disclosure provide a computer-readable storage medium having stored therein a computer-executable instruction or a computer program that, when executed by a processor, causes the processor to execute the method for processing a call task provided by the embodiments of the disclosure, e.g., the method for processing a call task shown in FIG. 3A.

The embodiments of the disclosure have the following beneficial effects.

With the embodiments of the disclosure, a weight assigned to a free agent for a call task is acquired, call parameters for executing the call task during a first time period are acquired, and a number of calls during a second time period is determined based on the assigned weight and the call parameters, the first time period and the second time period being adjacent time periods. Further, the call task is executed based on the number of calls and the assigned weight. In this way, the number of calls during the second time period is determined by taking into account the weight assigned to the free agent for the call task and the call parameters for executing the call task during the first time period, and the number of calls is predicted by taking into account both the dimensions of the task assignment weight of the agent and the call parameter, thereby improving the accuracy of predicting the number of calls. A free agent can be allocated to execute the call task by means of the number of calls and the weight assigned to the free agent for the call task, so as to avoid a situation in which there are too many free agents, improve the utilization rate of the agents, and improve the efficiency of processing the call task.

In some embodiments, the computer-readable storage medium may be a memory such as a ferroelectric random access memory (FRAM), a read-only memory (ROM), a programmable read-only memory (PROM), an erasable programmable read-only memory (EPROM), an electrically erasable programmable read-only memory (EEPROM), a flash memory, a magnetic surface memory, a compact disc, or a compact disc read-only memory (CD-ROM); or may be various devices including one or any combination of the above memories.

In some embodiments, the computer-executable instruction may be in the form of a program, a software, a software module, a script, or a code, and written in any form of programming language (including a compiled or interpreted language, or a declarative or procedural language), and may be deployed in any form, including as a stand-alone program or as a module, component, subroutine, or another unit suitable for use in a computing environment.

As an example, the computer-executable instruction may, but does not necessarily, correspond to a file in a file system, and may be stored in a part of a file storing other programs or data, for example, in one or more scripts in a hyper text markup language (HTML) document, in a single file dedicated to the program in question, or in a plurality of coordinated files (for example, files storing one or more modules, sub-programs, or code portions).

As an example, the computer-executable instruction may be deployed to be executed on an electronic device, or on a plurality of electronic devices located at one site, or on a plurality of electronic devices distributed at a plurality of sites and interconnected by a communication network.

The foregoing are merely embodiments of the disclosure, and are not intended to limit the scope of protection of the disclosure. Any modifications, equivalent substitutions, improvements, etc., made within the spirit and scope of the disclosure shall fall within the scope of protection of the disclosure.

1. A method for processing a call task, comprising:
acquiring a weight assigned to a free agent for a call task;
acquiring call parameters for executing the call task during a first time period;
determining a number of calls during a second time period based on the assigned weight and the call parameters, the first time period and the second time period being adjacent time periods; and
executing the call task based on the number of calls and the assigned weight.

2. The method of claim 1, wherein determining the number of calls during the second time period based on the assigned weight and the call parameters comprises:
accumulating weights assigned to different free agents for the call task, to obtain a cumulative sum;
determining a first number of calls based on the cumulative sum;
determining a second number of calls based on the call parameters; and
determining a minimum value among the first number of calls and the second number of calls, and determining the minimum value to be the number of calls during the second time period.

3. The method of claim 2, wherein the call parameters comprise: a number of calls that have been made, a number of calls that have been connected, a number of calls that have been hung up, a time in progress for a hit, and a service time, and determining the second number of calls based on the call parameters comprises:
acquiring a number of calls in progress, a first number of agents in a call state, a second number of agents that are free, and a third number of agents in a post operation state;
determining a connection success rate based on the number of calls that have been made and the number of calls that have been connected, and determining a predicted number of connections based on the number of calls in progress and the connection success rate;
determining a first predicted value based on the service time, the time in progress for a hit, and the first number of agents;
determining a call abandonment rate based on the number of calls that have been connected and the number of calls that have been hung up, and determining a predicted connection success rate based on the call abandonment rate and the connection success rate; and
determining the second number of calls based on the second number of agents, the third number of agents, the predicted number of connections, the first predicted value, and the predicted connection success rate.

4. The method of claim 3, wherein determining the second number of calls based on the second number of agents, the third number of agents, the predicted number of connections, the first predicted value, and the predicted connection success rate comprises:
determining a difference between the second number of agents and the predicted number of connections as a number of free agents;
determining a sum of the number of free agents, the first predicted value, and the third number of agents as a candidate number of calls;
adjusting the candidate number of calls using a preset adjustment coefficient, to obtain a predicted number of calls; and
determining the second number of calls based on the predicted number of calls and the predicted connection success rate.

5. The method of claim 3, wherein the call task corresponds to a plurality of agent sets, and executing the call task based on the number of calls and the assigned weight comprises:
acquiring a fourth number of agents that are free in each agent set;
determining a task weight corresponding to each agent set based on the fourth number of agents and the second number of agents;
determining, based on the task weight corresponding to each agent set and the number of calls, a number of calls allocated to each agent set; and
allocating the call task to a free agent in each agent set based on the number of calls allocated to each agent set and the assigned weight.

6. The method of claim 1, further comprising:
when at least two call tasks are allocated to a free agent, randomly determining a call task from the at least two call tasks as a target call task for the free agent; or,
acquiring a weight assigned to the free agent for each of the at least two call tasks; and determining a call task having a highest assigned weight as the target call task for the free agent.

7. An apparatus for processing a call task, comprising:
a memory, configured to store a computer-executable instruction or a computer program; and
a processor, configured to execute the computer-executable instruction or the computer program stored in the memory to:
acquire a weight assigned to a free agent for a call task;
acquire call parameters for executing the call task during a first time period;
determine a number of calls during a second time period based on the assigned weight and the call parameters, the first time period and the second time period being adjacent time periods; and
execute the call task based on the number of calls and the assigned weight.

8. The apparatus of claim 7, wherein the processor is further configured to execute the computer-executable instruction or the computer program to:
accumulate weights assigned to different free agents for the call task, to obtain a cumulative sum;
determine a first number of calls based on the cumulative sum;
determine a second number of calls based on the call parameters; and
determine a minimum value among the first number of calls and the second number of calls, and determine the minimum value to be the number of calls during the second time period.

9. The apparatus of claim 8, wherein the call parameters comprise: a number of calls that have been made, a number of calls that have been connected, a number of calls that have been hung up, a time in progress for a hit, and a service time, and the processor is further configured to execute the computer-executable instruction or the computer program to:
acquire a number of calls in progress, a first number of agents in a call state, a second number of agents that are free, and a third number of agents in a post operation state;
determine a connection success rate based on the number of calls that have been made and the number of calls that have been connected, and determine a predicted number of connections based on the number of calls in progress and the connection success rate;
determine a first predicted value based on the service time, the time in progress for a hit, and the first number of agents;
determine a call abandonment rate based on the number of calls that have been connected and the number of calls that have been hung up, and determine a predicted connection success rate based on the call abandonment rate and the connection success rate; and
determine the second number of calls based on the second number of agents, the third number of agents, the predicted number of connections, the first predicted value, and the predicted connection success rate.

10. The apparatus of claim 9, wherein the processor is further configured to execute the computer-executable instruction or the computer program to:
determine a difference between the second number of agents and the predicted number of connections as a number of free agents;
determine a sum of the number of free agents, the first predicted value, and the third number of agents as a candidate number of calls;
adjust the candidate number of calls using a preset adjustment coefficient, to obtain a predicted number of calls; and
determine the second number of calls based on the predicted number of calls and the predicted connection success rate.

11. The apparatus of claim 9, wherein the call task corresponds to a plurality of agent sets, and the processor is further configured to execute the computer-executable instruction or the computer program to:
acquire a fourth number of agents that are free in each agent set;
determine a task weight corresponding to each agent set based on the fourth number of agents and the second number of agents;
determine, based on the task weight corresponding to each agent set and the number of calls, a number of calls allocated to each agent set; and
allocate the call task to a free agent in each agent set based on the number of calls allocated to each agent set and the assigned weight.

12. The apparatus of claim 7, wherein the processor is further configured to execute the computer-executable instruction or the computer program to:
when at least two call tasks are allocated to a free agent, randomly determine a call task from the at least two call tasks as a target call task for the free agent; or,
acquire a weight assigned to the free agent for each of the at least two call tasks; and determine a call task having a highest assigned weight as the target call task for the free agent.

13. A non-transitory computer-readable storage medium, having stored thereon a computer-executable instruction or a computer program that, when executed by a processor, causes the processor to implement operations comprising:
acquiring a weight assigned to a free agent for a call task;
acquiring call parameters for executing the call task during a first time period;
determining a number of calls during a second time period based on the assigned weight and the call parameters, the first time period and the second time period being adjacent time periods; and
executing the call task based on the number of calls and the assigned weight.

14. The non-transitory computer-readable storage medium of claim 13, wherein determining the number of calls during the second time period based on the assigned weight and the call parameters comprises:
accumulating weights assigned to different free agents for the call task, to obtain a cumulative sum;
determining a first number of calls based on the cumulative sum;
determining a second number of calls based on the call parameters; and
determining a minimum value among the first number of calls and the second number of calls, and determining the minimum value to be the number of calls during the second time period.

15. The non-transitory computer-readable storage medium of claim 14, wherein the call parameters comprise: a number of calls that have been made, a number of calls that have been connected, a number of calls that have been hung up, a time in progress for a hit, and a service time, and determining the second number of calls based on the call parameters comprises:
acquiring a number of calls in progress, a first number of agents in a call state, a second number of agents that are free, and a third number of agents in a post operation state;
determining a connection success rate based on the number of calls that have been made and the number of calls that have been connected, and determining a predicted number of connections based on the number of calls in progress and the connection success rate;
determining a first predicted value based on the service time, the time in progress for a hit, and the first number of agents;
determining a call abandonment rate based on the number of calls that have been connected and the number of calls that have been hung up, and determining a predicted connection success rate based on the call abandonment rate and the connection success rate; and
determining the second number of calls based on the second number of agents, the third number of agents, the predicted number of connections, the first predicted value, and the predicted connection success rate.

16. The non-transitory computer-readable storage medium of claim 15, wherein determining the second number of calls based on the second number of agents, the third number of agents, the predicted number of connections, the first predicted value, and the predicted connection success rate comprises:
determining a difference between the second number of agents and the predicted number of connections as a number of free agents;
determining a sum of the number of free agents, the first predicted value, and the third number of agents as a candidate number of calls;
adjusting the candidate number of calls using a preset adjustment coefficient, to obtain a predicted number of calls; and
determining the second number of calls based on the predicted number of calls and the predicted connection success rate.

17. The non-transitory computer-readable storage medium of claim 15, wherein the call task corresponds to a plurality of agent sets, and executing the call task based on the number of calls and the assigned weight comprises:
acquiring a fourth number of agents that are free in each agent set;
determining a task weight corresponding to each agent set based on the fourth number of agents and the second number of agents;
determining, based on the task weight corresponding to each agent set and the number of calls, a number of calls allocated to each agent set; and
allocating the call task to a free agent in each agent set based on the number of calls allocated to each agent set and the assigned weight.

18. The non-transitory computer-readable storage medium of claim 13, wherein the operations further comprise:
when at least two call tasks are allocated to a free agent, randomly determining a call task from the at least two call tasks as a target call task for the free agent; or,
acquiring a weight assigned to the free agent for each of the at least two call tasks; and determining a call task having a highest assigned weight as the target call task for the free agent.
